(19) United States
(12) Patent Application Publication
(10) Pub. No.: US 2013/0067753 A1
(43) Pub. Date: Mar. 21, 2013

(54) BOLT SORTER FOR DETERMINING SIZE AND THREAD PITCH OF BOLTS

(71) Applicant: Mark Edward Diehl, Sidney, OH (US)

(72) Inventor: Mark Edward Diehl, Sidney, OH (US)

(21) Appl. No.: 13/620,277

(22) Filed: Sep. 14, 2012

Related U.S. Application Data
(60) Provisional application No. 61/537,193, filed on Sep. 21, 2011.

(51) Int. Cl. G01B 3/36

(52) U.S. Cl. 33/199 R

(57) ABSTRACT

A bolt sorter quickly and easily determines the size and thread pitch of a bolt. The bolt sorter includes a plurality of semi-circular threaded profiles that are sized and have threads cut to accept bolts into the profile. If the bolt is of the correct diameter and thread pitch, the bolt will fit into the semi-circular threaded profile. Unlike conventional devices that usually require the bolts to be threaded into holes, users can quickly insert bolts into the threaded profiles of the bolt sorter to determine their size and thread pitch. The bolt sorter can be sized for standard and metric sized bolts and can include multiple thread pitch profiles for each bolt diameter.

### CROSS-REFERENCE TO RELATED APPLICATION

This application claims the benefit of priority of U.S. provisional application No. 61/537,193, filed Sep. 21, 2011, the contents of which are herein incorporated by reference.

### BACKGROUND OF THE INVENTION

The present invention relates to hand tools and, more particularly, to a hand tool that quickly and easily determines the size and thread pitch of bolts.

Bolts come in a variety of sizes and thread pitches. Many times, individuals will have a collection of bolts and will want to sort them according to size and thread pitch. It can be, for example, difficult to see the difference between a #8-32 thread pitch bolt and a #10-32 thread pitch bolt. It can also be difficult to determine the difference between a #10-32 thread pitch bolt and a #10-24 thread pitch bolt. Those familiar with threads may be able to do this, but there are nearly identical metric/standard threads that are impossible to visually determine any difference. For example, ⅜-16 standard bolt has a bolt diameter of 0.375, while a 10-1.5 metric bolt has a bolt diameter of only 0.018 more (0.393). Similarly a ⅜-16 standard bolt has a thread pitch of 0.062, while a 10-1.5 metric bolt has a thread pitch of just 0.003 less (0.059).

Devices have been made to help a user make this determination. One such device can include a plurality of holes to determine bolt diameter while another device can check thread pitch. Other devices can include threaded holes where a user can thread their bolts into the holes to determine the size and thread pitch of the bolt. These devices, however, take time, as a user has to individually thread each bolt to test size, and then unthread the bolt once the size and thread pitch is determined. With these devices, a user may try to thread different thread pitch bolts in the wrong hole which, after time, can damage the threads, making it difficult for threading the correct sized bolts into the hole.

As can be seen, there is a need for an improved device for quickly and easily determining the thread pitch and size of bolts.

### SUMMARY OF THE INVENTION

In one aspect of the present invention, a device for determining the size and thread pitch of bolts comprises a plurality of semi-circular threaded profiles formed in at least one side of the device, wherein the threaded profiles are designed to fit a bolt of a specific size and thread pitch.

In another aspect of the present invention, a method for determining size and thread pitch of a bolt comprises inserting threads of the bolt into a semi-circular threaded profile of a bolt sorting device, the bolt sorting device having a plurality of the semi-circular threaded profiles formed in at least one side of the device; finding one of the plurality of the semi-circular threaded profiles into which the bolt can be fully inserted; and noting the size and thread pitch of the fitting semi-circular threaded profile.

These and other features, aspects and advantages of the present invention will become better understood with reference to the following drawings, description and claims.

### BRIEF DESCRIPTION OF THE DRAWINGS

FIG. 1 is a perspective view of a bolt sorter according to an exemplary embodiment of the present invention;

FIG. 2 is a top view of the bolt sorter of FIG. 1;

FIG. 3 is a front view of the bolt sorter of FIG. 1; and

FIG. 4 is a front view of a double sided bolt sorter according to an exemplary embodiment of the present invention, including one side for metric sizes and a second side for standard sizes.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a bolt sorter for quickly and easily determining the size and thread pitch of a bolt. The bolt sorter includes a plurality of semi-circular threaded profiles that are sized and have threads cut to accept bolts into the profile. If the bolt is of the correct diameter and thread pitch, the bolt will fit into the semi-circular threaded profile. Unlike conventional devices that usually require the bolts to be threaded into holes, users can quickly insert bolts into the threaded profiles of the bolt sorter to determine their size and thread pitch. The bolt sorter can be sized for standard and metric sized bolts and can include multiple thread pitch profiles for each bolt diameter.

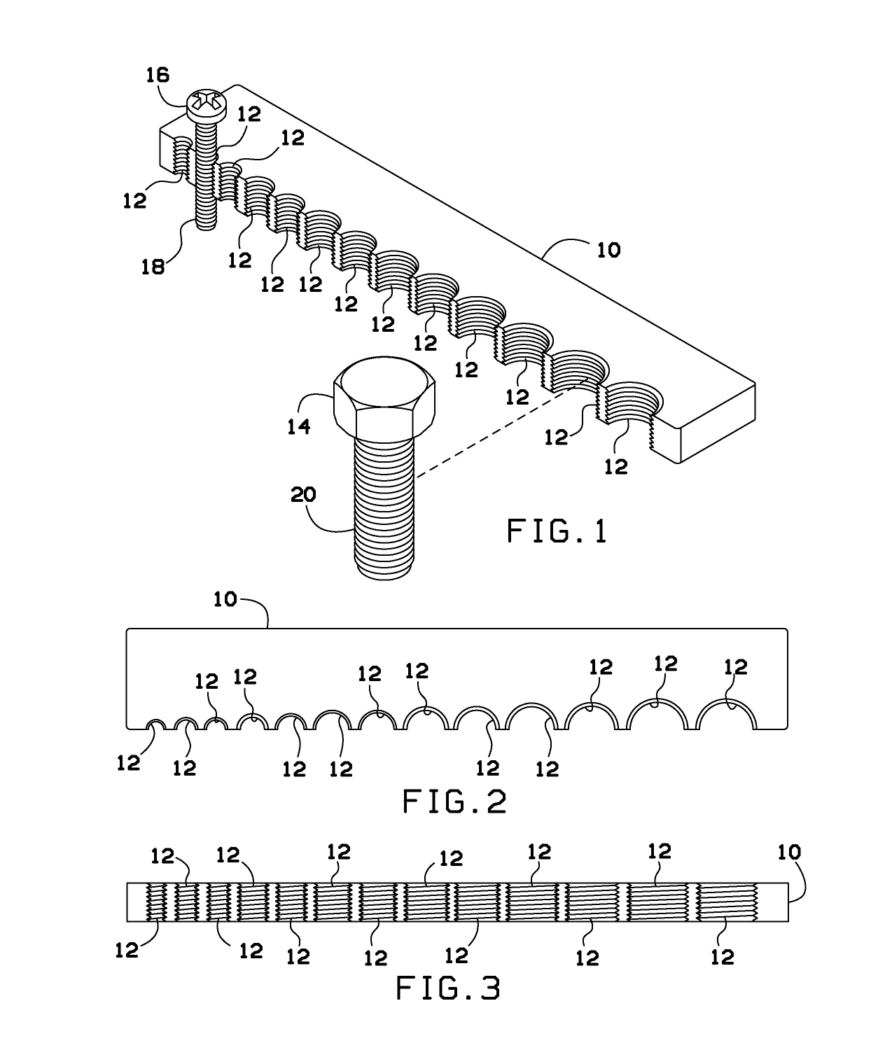

Referring now to FIGS. 1 through 3, a bolt sorter 10 can include a plurality of semi-circular threaded profiles 12. The semi-circular threaded profiles 12 can be shaped from about 150 to about 180 degrees of a circle, typically from about 170 to about 180 degrees of a circle.

Threads 20 of a large bolt 14 can be fit into the correct threaded profile 12, as shown by the dotted line in FIG. 1, to allow a user to quickly and easily determine the size and thread pitch of the bolt 14. The size and thread pitch of a small bolt 16 can also be determined with the bolt sorter 10.

The bolt sorter 10 can include a plurality of threaded profiles 12, for example, from about 5 to about 20, typically from about 10 to about 15 threaded profiles 12. The bolt softer 10 can include indicia (not shown) at each of the threaded profiles 12 to show the representative size and thread pitch.

The bolt sorter 10 can be designed with one flat edge opposite the threaded profiles 12, as shown in the Figures. In some embodiments, threaded profiles 12 can be cut in both sides of the bolt sorter 10. In some embodiments, metric bolt sizes/thread pitch can be cut along one side of the bolt sorter 10 and standard bolt sizes/thread pitch can be cut along an opposite side of the bolt softer 10. In other embodiments, different bolt sorters 10 can be used for metric and standard threads. As used herein, “standard” threads include unified national course (UNC) and unified national fine (UNF) threads.

Moreover, different size ranges for bolt sorters 10 can be designed. For example, an electronics or computer technician may have a bolt sorter for bolts from size #2 to #10, for example, while an automotive technician may have a bolt softer for bolts from ¼ inch to ¾ inch, for example.

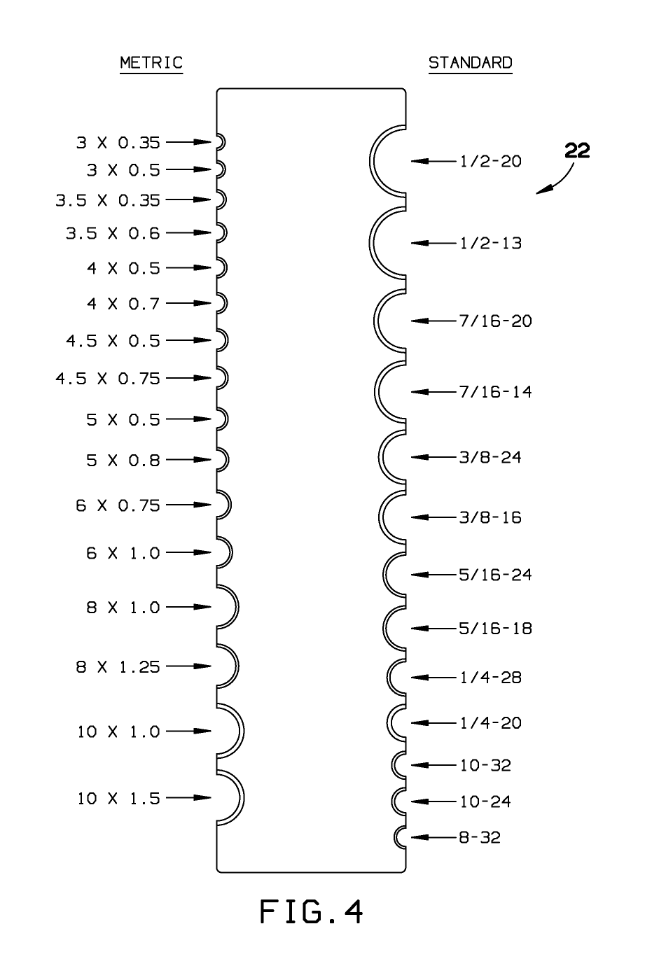

In some embodiments, a dual standard/metric bolt sorter 22 can be formed having threaded profiles along opposite sides thereof. As shown in FIG. 4, one size could include a set of metric sizes and the opposite could include a set of standard sizes. The sizes shown in FIG. 4 are examples of the sizes and thread pitches that could be used on the bolt sorter 22 and other sizes may be formed, depending on the user's needs.

The bolt sorter 10 can be made in various thicknesses, such as from about ¼ inch to about 1 inch thick, provided that the thickness allows a user to insert a bolt and determine an adequate fit within the threaded profiles.

The bolt sorter 10 can be made from various materials, such as plastic, metal, composite or the like. The bolt sorter 10 can be made in manufacturing processes known in the art, such as injection molding, CNC machining or the like.

It should be understood, of course, that the foregoing relates to exemplary embodiments of the invention and that modifications may be made without departing from the spirit and scope of the invention as set forth in the following claims.

What is claimed is:

1. A device for determining the size and thread pitch of bolts, comprising:
a plurality of semi-circular threaded profiles formed in at least one side of the device, wherein the threaded profiles are designed to fit a bolt of a specific size and thread pitch.

2. The device of claim 1, wherein from about 10 to about 15 semi-circular threaded profiles are formed in one side of the device.

3. The device of claim 1, wherein the semi-circular threaded profile form arcs from about 170 to about 180 degrees.

4. The device of claim 1, wherein the semi-circular threaded profile form arcs of about 180 degrees.

5. The device of claim 1, wherein the size and thread pitch are standard sizes and thread pitches.

6. The device of claim 1, wherein the size and thread pitch are metric sizes and thread pitches.

7. A method for determining size and thread pitch of a bolt, the method comprising:
inserting threads of the bolt into a semi-circular threaded profile of a bolt sorting device, the bolt sorting device having a plurality of the semi-circular threaded profiles formed in at least one side of the device;
finding one of the plurality of the semi-circular threaded profiles into which the bolt can be fully inserted; and
noting the size and thread pitch of the fitting semi-circular threaded profile.

8. The method of claim 7, wherein the semi-circular threaded profile form arcs from about 170 to about 180 degrees.

9. The device of claim 7, wherein the semi-circular threaded profile form arcs of about 180 degrees.
